(19) United States
(12) Patent Application Publication
(10) Pub. No.: US 2021/0293917 A1
(43) Pub. Date: Sep. 23, 2021

(54) METHOD, DEVICE AND COMPUTER READABLE MEDIUM FOR BEAM INFORMATION BASED POSITIONING

(71) Applicant: NEC CORPORATION, Tokyo (JP)

(72) Inventors: Fang YUAN, Beijing (CN); Gang WANG, Beijing (CN)

(73) Assignee: NEC CORPORATION, Tokyo (JP)

(21) Appl. No.: 17/257,709

(22) PCT Filed: Jul. 6, 2018
(86) PCT No.: PCT/CN2018/094920

§ 371 Date: Jan. 4, 2021

(51) Int. Cl. G01S 5/08; G01S 5/02; H04B 7/06; H04W 64/00

(52) U.S. Cl. CPC G01S 5/08; G01S 5/0244; H04W 64/006; H04B 7/0639; H04B 7/0695

(57) ABSTRACT

Embodiments of the present disclosure relate to methods, devices and computer readable media for beam information based positioning. In example embodiments, a method implemented in a network device includes transmitting reference signals in a plurality of beams having different directions; receiving, from a terminal device, a signal indicating beam information of a beam selected from the plurality of beams by the terminal device based on signal qualities of the plurality of beams, the signal qualities being determined based on the reference signal transmitted in the plurality of beams; and determining a position of the terminal device based at least in part on the beam information.

### TECHNICAL FIELD

Embodiments of the present disclosure generally relate to the field of communication, and in particular, to methods, devices and computer readable media for beam information based positioning.

### BACKGROUND

Communication technologies have been developed in various communication standards to provide a common protocol that enables different wireless devices to communicate on a municipal, national, regional, and even global level. An example of an emerging communication standard is new radio (NR), for example, 5G radio access. NR is a set of enhancements to the Long Term Evolution (LTE) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL) as well as support beamforming, multiple-input multiple-output (MIMO) antenna technology, and carrier aggregation.

With the development of wireless communication technology, the location-based service has become one of the most promising mobile Internet services. Whether in indoor or outdoor environments, the need to quickly and accurately obtain location information and provide location based services for user equipment (UE) is becoming increasingly urgent. For example, the positioning of UE is expected to be enhanced to high target accuracy (e.g., 0.5 m) in NR. However, the conventional schemes for positioning UEs cannot satisfy the requirement for the high target accuracy in NR.

### SUMMARY

In general, example embodiments of the present disclosure provide methods, devices and computer readable media for beam information based positioning.

In a first aspect, there is provided a method implemented in a network device. The method comprises transmitting reference signals in a plurality of beams having different directions; receiving, from a terminal device, a signal indicating beam information of a beam selected from the plurality of beams by the terminal device based on signal qualities of the plurality of beams, the signal qualities being determined based on the reference signal transmitted in the plurality of beams; and determining a position of the terminal device based at least in part on the beam information.

In a second aspect, there is provided a method implemented in a network device. The method comprises transmitting to a terminal device a request for triggering an uplink positioning-related signal; in response to receiving the uplink positioning-related signal from the terminal device in a plurality of beams, determining signal qualities of the plurality of beams based on the uplink positioning-related signal in the plurality of beams; determining a beam in the plurality of beams based on the determined signal qualities; and determining a position of the terminal device based at least in part on the uplink positioning-related signal in the determined beam.

In a third aspect, there is provided a method implemented in a terminal device. The method comprises receiving from a network device reference signals transmitted in a plurality of beams having different directions; determining signal qualities of the plurality of beams based on the reference signal transmitted in the plurality of beams; selecting a beam from the plurality of beams based on the determined signal qualities; and transmitting to the network device a signal indicating beam information of the selected beam.

In a fourth aspect, there is provided a method implemented in a terminal device. The method comprises in response to receiving from a network device a request for triggering an uplink positioning-related signal, transmitting the uplink positioning-related signal in a plurality of beams having different directions, such that the network device determines a beam from the plurality of beams and determines a position of the terminal device based at least in part on the uplink positioning-related signal in the determined beam.

In a fifth aspect, there is provided a network device. The device includes a processor; and a memory coupled to the processing unit and storing instructions thereon, the instructions, when executed by the processing unit, causing the device to perform the method according to the first aspect.

In a sixth aspect, there is provided a network device. The device includes a processor; and a memory coupled to the processing unit and storing instructions thereon, the instructions, when executed by the processing unit, causing the device to perform the method according to the second aspect.

In a seventh aspect, there is provided a terminal device. The device includes a processor; and a memory coupled to the processing unit and storing instructions thereon, the instructions, when executed by the processing unit, causing the device to perform the method according to the third aspect.

In a eighth aspect, there is provided a terminal device. The device includes a processor; and a memory coupled to the processing unit and storing instructions thereon, the instructions, when executed by the processing unit, causing the device to perform the method according to the fourth aspect.

In a ninth aspect, there is provided a computer readable medium having instructions stored thereon, the instructions, when executed on at least one processor, causing the at least one processor to carry out the method according to the first aspect.

In a tenth aspect, there is provided a computer readable medium having instructions stored thereon, the instructions, when executed on at least one processor, causing the at least one processor to carry out the method according to the second aspect.

In a eleventh aspect, there is provided a computer readable medium having instructions stored thereon, the instructions, when executed on at least one processor, causing the at least one processor to carry out the method according to the third aspect.

In a twelfth aspect, there is provided a computer readable medium having instructions stored thereon, the instructions, when executed on at least one processor, causing the at least one processor to carry out the method according to the fourth aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 is a schematic diagram illustrating a process for beam information based positioning according to some embodiments of the present disclosure;

FIG. 3 is a schematic diagram illustrating a plurality of first-type beams according to some embodiments of the present disclosure;

FIG. 4 is a schematic diagram illustrating a plurality of first-type beams and a plurality of second-type beams associated with one of the plurality of first-type beams according to some other embodiments of the present disclosure;

FIG. 5A illustrates a graph of the signal qualities varying with beam direction according to some embodiments of the present disclosure;

FIG. 5B illustrates a graph of an adjusting factor varying with beam direction according to some embodiments of the present disclosure;

FIG. 6 is a schematic diagram illustrating a process for a beam based positioning according to some embodiments of the present disclosure;

FIG. 7 is a schematic diagram illustrating a plurality of beams transmitted by a terminal device according to some embodiments of the present disclosure;

FIG. 8 shows a flowchart of an example method in accordance with some embodiments of the present disclosure;

FIG. 9 shows a flowchart of an example method in accordance with some other embodiments of the present disclosure;

FIG. 10 shows a flowchart of an example method in accordance with some further embodiments of the present disclosure;

FIG. 11 shows a flowchart of an example method in accordance with some other yet further embodiments of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, and the like. For the purpose of discussion, in the following, some embodiments will be described with reference to gNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

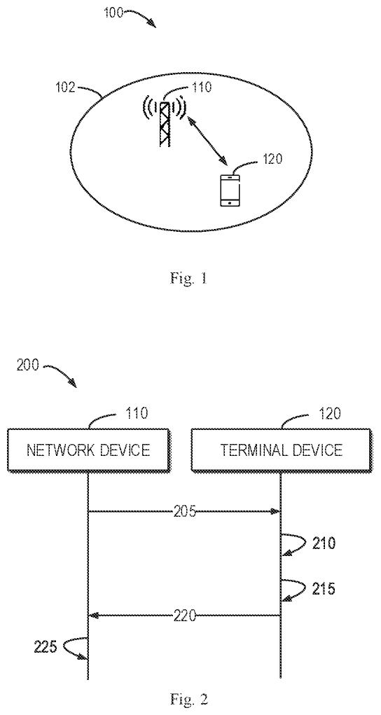

FIG. 1 shows an example communication network 100 in which embodiments of the present disclosure can be implemented. The network 100 includes a network device 110 and a terminal device 120 served by the network device 110. The serving area of the network device 110 is called as a cell 102. It is to be understood that the number of network devices and terminal devices is only for the purpose of illustration without suggesting any limitations. The network 100 may include any suitable number of network devices and terminal devices adapted for implementing embodiments of the present disclosure. Although not shown, it is to be understood that one or more terminal devices may be located in the cell 102 and served by the network device 110.

In the communication network 100, the network device 110 can communicate data and control information to the terminal device 120 and the terminal device 120 can also communication data and control information to the network device 110. A link from the network device 110 to the terminal device 120 is referred to as a downlink (DL) or a forward link, while a link from the terminal device 120 to the network device 110 is referred to as an uplink (UL) or a reverse link.

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

In embodiments, the network device 110 is configured to implement beamforming technique and transmit signals to the terminal device 120 in a plurality of beams. The terminal device 120 is configured to receive the signals transmitted by the network device 110 in the plurality of beams.

Conventionally, to localize a position of a terminal device, for example, a UE, a variety of positioning methods have been used, such as Cell ID or E-Cell ID, observed time difference of arrival (OTDOA), uplink time difference of arrival (U-TDOA), Angle-of-Arrival (AOA), for example. As an example, in the communication system using U-TDOA, the UE transmits an uplink positioning-related signal, and at least three base stations distributed in a reasonable geometry around the UE measure the time difference of arrive (TDOA) of the uplink position signal. The location of the UE is then determined based on the location of the at least three base stations and the measured time differences of arrive. In some very rural environments where base station spacing is very large and geometries are limited by constrained network coverage (e.g. very rural highways, mountainous areas, etc.), the fundamental requirement cannot be achieved and accuracy of U-TDOA degrades.

Other conventional positioning methods have their own characteristics. The following Table 1 shows the coverage, advantages (pros) and disadvantages (cons) of some conventional positioning methods. Generally, it is difficult for these conventional positioning methods to satisfy the requirement for the target accuracy in NR.

TABLE 1
A comparison of some conventional positioning methods

| | | | | | | RF |
|---|---|---|---|---|---|---|
| Methods | A-GNSS | OTDOA | E-CID | U-TDOA | GPS | Fingerprinting |
| coverage | Good | Good | High | Good | moderate in | moderate in |
| | | | | | urban area, | urban area, low |
| | | | | | high in rural | in rural area |
| | | | | | area | |
| pros | conserves | useful in | Good for | minimal | highest | not dependent |
| | battery, | dense urban | indoor | additional | accuracy | on handset |
| | reduced | and indoor | devices | network | | technologies |
| | TTFF | environments | | load | | |
| cons | Accuracy | Needs three | Needs | uplink | Doesn't work | large amount of |
| | varies | base stations, | expensive | power | well indoor, | additional |
| | with | hardware | adaptive | control | battery | software |
| | location | and firmware | antenna | interferes | consumption, | |
| | | support is | | with this | high TFFF | |
| | | needed in | | method | | |
| | | UE | | | | |

Beamforming is a signal processing technique used for directional signal transmission or reception. This is achieved by combining elements in an antenna array in such a way that signals at particular angles experience constructive signal while others experience destructive signal. As mentioned above, beamforming is supported in NR. In particular, hybrid beamforming which is joint analog and digital beamforming and is not present in the 3G and 4G communication systems is enabled in NR. Hybrid beamforming enables beams with a narrower beam-width and thus beam information may be used to determine the position of UEs.

There have been some solutions for UE positioning based on beamforming technique. According to one solution, UE is localized and tracked in the radio frequency (RF) beam areas of an LTE wireless system employing Agile Beam Forming techniques. In this solution, at least one of Channel Quality Indicator (CQI) and Sounding Reference Signal (SRS) is measured by higher layer configuration to determine the location of UE. According to another solution, different beamformed reference signals are transmitted at different times from base stations to UE. Measurement reports each indicating measurement parameters associated with the beamformed reference signals, such as CQI and estimated AoA, are provided by the UE to determine the location of the UE. However, in these solutions, beam information such as the direction of beam is not involved in the positioning of UEs.

According to embodiments of the present disclosure, there is prosed a solution for beam information based positioning. In this solution, reference signals are transmitted by a network device in a plurality of beams to a terminal device for the purpose of positioning. The terminal device select a beam from the plurality of beams based on signal qualities of the reference signals in the plurality of beams and transmits to the network device a signal indicating the beam information of the selected beam. The position of the terminal device is further determined based on the beam information.

Principle and implementations of the present disclosure will be described in detail below with reference to FIG. 2, which shows a process 200 for beam information based positioning according to some embodiments of the present disclosure. For the purpose of discussion, the process 200 will be described with reference to FIG. 1. The process 200 may involve the network device 110 and the terminal device 120 in FIG. 1.

In NR, a network device may be configured with an array of antennas, which may be further divided into a plurality of subarrays of phased antenna elements. Such an array of antennas enables hybrid beamforming of signals transmitted by the network device. In embodiments, the network device 110 (e.g., a gNB) may implement hybrid beamforming. Thus, the plurality of beams transmitted by the network device 110 may include beams of first type which are formed for example but not limit to by analog beamforming (also referred to as first-type beams), and beams of second type which are formed for example but not limit to by digital beamforming (also referred to as second-type beams). The reference signals for first-type and second-type beams may have different configurations. For example, the reference signal for first-type beams and second-type beams may be configured as wideband and subband respectively. It is to be understood that the terms “first-type beams” and “second-type beams” are used only to distinguish different types of beams without limiting the scope of the present disclosure.

The network device 110 transmits 205 to the terminal device 120 reference signals (RS) in a plurality of beams having different directions. Various types of reference signals can be utilized for the purpose of positioning, for example, channel-state-information reference signal (CSI-RS) and synchronization-signal-block (SSB), and positioning reference signal (PRS).

After receiving the reference signals in the plurality of beams, the terminal device 120 determines 210 signal qualities (or signal strengths) of the plurality of beams based on the reference signal transmitted in the plurality of beams. The parameters which can be used to evaluate the signal qualities of the plurality of beams include, but not limited to, reference signal received power (RSRP), reference signal received quality (RSRQ), CQI and signal-to-noise ratio (SNR). For example, the RSRP of the reference signal in each of the plurality of beams may be measured.

Upon determining the signal qualities, the terminal device 120 selects 215 a beam from the plurality of beams based on the determined signal qualities. The signal quality of the selected beam may be better than that of other beams. In embodiments where the RSRP is measured, the terminal device 120 may select one beam from the plurality of beams in which the RSRP of the reference signal is larger than that in other beams in the plurality of beams. In embodiments where the SNR is measure, the terminal device 120 may select one beam from the plurality of beams in which the SNR of the reference signal is larger than that in other beams of the plurality of beams.

The terminal device 120 transmits 220 to the network device 110 a signal indicating beam information of the selected beam. It is to be understood that the beam information may also comprise information on other beams of the plurality of beams, as will be described below. In some embodiments, the signal may be transmitted over a uplink control channel, e.g., Physical Uplink Control Channel (PUCCH), and the beam information may be explicitly included in the signal. For example, in the case where the reference signal is CSI-RS, the beam information may be related to CSI-RS resource indicator (CRI) and thus may be included in a CSI report. In the case where the reference signal is SSB, the beam information may be related to SSB resource indicator (SSB-RI). In some other embodiments, the beam information may be implicitly included in the signal. For example, the sequence indexes of the signal may indicate the beam information, which is further described below. Both the cases where the beam information is explicitly or implicitly included in the signal will be described in detail below. Since only the index of the selected beam is transmitted to the network device 110, the terminal device 120 does not need to have the knowledge the direction of each beam.

In some embodiments, the beam information may only include information about the selected beam. In some embodiments, the beam information may further include information about at least one other beam. Descriptions of the beam information will be detailed below.

Upon reception of the signal transmitted by the terminal device 120, the network device 110 determines 225 a position of the terminal device based at least in part on the beam information. By interpreting the beam information indicated by the received signal, the network device 110 may determine which beam of the plurality of beams has been selected by the terminal device 120. The network device 110 may further determine, based on the physical direction of the selected beam, a direction of the terminal device 120 relative to the network device 110 (also referred to as a first direction for ease of discussion). For example, a direction of the beam center of the selected beam may be used as the first direction. Alternatively or additionally, the range of direction covered by the beam-width of the selected beam may be used as a range of direction of the terminal device 120, which provides a further estimation of positioning accuracy.

In some embodiments, the network device 110 may obtain a second direction of the terminal device 120 relative to a further network device (not shown). For example, the network device 110 may receive the second direction from the terminal device 120 or the further network device. Then, the position of the terminal device 120 may be determined based on the first direction and the second direction. Alternatively or additionally, directions of the terminal device 120 relative to more than one further network devices may be obtained. In this case, the accuracy of the determined position of the terminal device 120 can be improved.

In some embodiments, the network device 110 may obtain a distance of the terminal device 120 relative to the network device 110. For example, the distance may be determined by measuring a time of arrive (TOA), or timing advance (TA) of another uplink positioning-related signal transmitted by the terminal device 120 to the network device 110. Then, the position of the terminal device 120 may be determined based on the first direction and the distance.

In the process 200 described above with reference to FIG. 2, the position of a terminal device is determined based on a direction of the selected beam. Due to the narrow beam-width of the beams, the positioning accuracy may be greatly enhanced and may satisfy the requirement in NR.

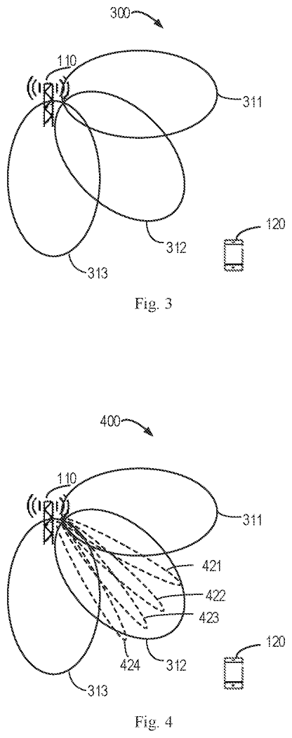

Now more embodiments about how to select a beam from the plurality of beams and how the signal transmitted by the terminal device 120 indicate the beam information will be described in detail with reference to FIGS. 3 and 4. FIG. 3 is a schematic diagram 300 illustrating a plurality of first-type beams 311-313 in which the reference signal is transmitted from the network device 110 to the terminal device 120. In the following description, the downlink reference signal is described with respect to CSI-RS, although it is to be understood that other types of reference signal can be used.

In some embodiments, only the first-type beams are involved in the positioning process. Three first-type beams 311-313 are shown in FIG. 3. It would be appreciated that FIG. 3 is provided for purpose of illustration only without suggesting any limitations and other number of first-type beams is also appreciated.

In the illustrated case, the terminal device 120 may determine that the signal quality of the first-type beam 312 is better than that of the first-type beams 311 and 313. For example, the terminal device 120 may determine that the RSRP of CRI-RS in the first-type beam 312 is higher than that in the first-type beams 311 and 313. Thus, the first-type beam 312 may be selected by the terminal device 120.

Then, the terminal device 120 may determine an index of the first-type beam 312 which is to be included in the beam information. For ease of discussion, the index of the first-type beam 312 is referred to as a first index. As mentioned above, in the case of CSI-RS, CRI may be used as an index of the first-type beam. As an example, the indexes of the first-type beams 311-313 may correspond to CRIs of 0, 1 and 2, respectively. Thus, the terminal device 120 may determine a CRI of 1 as the first index and include the first index in the beam information. In this case, after receiving the signal transmitted at step 220, by interpreting the first index, the network device 110 may determine that the first-type beam 312 has been selected by the terminal device 120 and then determine the position of the terminal device 120 based on the direction of the first-type beam 312. It is to be understood that the values of CRI are only for the purpose of illustration without suggesting any limitations.

In some embodiments, the second-type beams are involved in the positioning process. FIG. 4 is a schematic diagram 400 illustrating three first-type beams 311-313 and a plurality of second-type beams 421-424 associated with the first-type beams 312. Four second-type beams 421-424 are shown in FIG. 3. It would be appreciated that FIG. 4 is provided for purpose of illustration only without suggesting any limitations and other number of second-type beams is also appreciated. Although not shown, it is to be understood that there may be a plurality of second-type beams associated with the first-type beams 311 and 313.

In this case, the terminal device 120 may determine the signal qualities of the second-type beams 421-424 (the terminal device 120 may also determine the signal qualities of the second-type beams not shown) and determine that the signal quality of the second-type beam 422 is better than that of the second-type beams 421, 423 and 424. For example, the terminal device 120 may determine that the RSRP of CRI-RS in the second-type beam 422 associated with first-type beam 312 is higher than that in the second-type beams 421, 423 and 424. Thus, the second-type beam 422 may be selected by the terminal device 120.

Then, the terminal device 120 may determine information about the second-type beam 422 which is to be included in the beam information. The terminal device 120 may determine a first index which indicates a first-type beam associated with the second-type beam 422 and a second index which indicates the second-type beam 422 in the plurality of second-type beams 421-424 associated with that first-type beam. In the illustrated case, the first index corresponds to an indication of the first-type beam 312 and the second index corresponds to an indication which distinguishes the second-type beam 422 from the second-type beams 421, 423 and 424.

Depending on the configuration of the network 100, different types of indication or indicator may be used as the first index and the second index. If a CSI-RS resource has a plurality of antenna ports corresponding thereto, then a CRI corresponds to the first index and a port indicator (PI) corresponds to the second index. As an example, the second-type beams 421-424 may correspond to PIs of 1, 2, 3 and 4, respectively. Thus, the terminal device 120 may determine a CRI of 1 as the first index and a PI of 2 as the second index, and include the first index and the second index in the beam information. The two indexes can be encoded jointly or separately when indicating by the terminal device 120 to the network device 110. If the two indexes are jointly indicated and each of the first-type beams is associated with four second-type beams, the two indexes can be encoded with a single index ranging from 0-11, and in this case one index 5 can be indicated. If separately reported, a pair of two indexes (e.g., (1,2)) can be indicated. In this case, after receiving the signal transmitted at step 220, by interpreting the first and second indexes, the network device 110 may determine that the second-type beam 422 has been selected by the terminal device 120 and then determine the position of the terminal device 120 based on the direction of the second-type beam 422. It is to be understood that the values of CRIs and PIs are only for the purpose of illustration without suggesting any limitations.

If a CSI-RS resource has one antenna port corresponding thereto and a plurality of CSI-RS resources make up of a CSI-RS resource set, then a set index corresponds to the first index and a CRI corresponds to the second index. In this case, the first-type beams 311-313 may correspond to set indexes of 0, 1 and 2, and the second-type beams 421-424 may correspond to CRIs of 1, 2, 3 and 4. Thus, the terminal device 120 may determine a set index of 1 as the first index and a CRI of 2 as the second index, and include the first index and the second index in the beam information. It is to be understood that the values of the set indexes and CRIs are only for the purpose of illustration without suggesting any limitations.

Since a joint second-type and first-type beam has a narrower beam-width than an first-type beam, positioning accuracy in these embodiments can be improved. Further, it is to be understood by a person skilled in the art that regardless of what kind of indication or indicator is used, the first index and the second index are intended to identify the selected beam.

As mentioned above, the beam information may comprise information about other beams than the selected beam. In some embodiments, information about another beam in the plurality of beams may be included in the beam information. This information is provided to assist the positioning of the terminal device 120. For ease of discussion, the beam other than the selected beam, whose information is also included in the beam information, is referred to as an auxiliary beam. The auxiliary beam may be any of the plurality of beams which is different from the selected beam. For example, the auxiliary beam may be the strongest neighbor beam of the selected beam or may be either of the neighbor beams of selected beam. In these embodiments, the beam information may comprise a first indication of the selected beam and a second indication of the auxiliary beam. The signal qualities of the reference signal in both the selected beam and the auxiliary beam may also be included in the beam information.

In embodiments where only the first-type beams are involved, if the selected beam is the first-type beam 312 shown in FIG. 3, then the auxiliary beam may be either the first-type beam 311 or the first-type beam 313. Alternatively or additionally, the auxiliary beam may be the first-type beam which has a second best signal quality. As an example, the first-type beam 313 is selected by the terminal device 120 as the auxiliary beam. In this case, the terminal device 120 may determine a CRI of 1 as the index of the selected beam and determine the signal quality of the reference signal in the first-type beam 312, and include them in the beam information as the first indication. The terminal device 120 may further determine a CRI of 2 as the index of the auxiliary beam and determine the signal quality of the reference signal in the first-type beam 313, and include them in the beam information as the second indication.

In embodiments where the second-type beams are involved, if the selected beam is the second-type beam 422 shown in FIG. 4, then the auxiliary beam may be either the second-type beam 421 or the second-type beam 423. Alternatively or additionally, the auxiliary beam may be the second-type beam which has a second best signal quality. As an example, the second-type beam 423 is selected by the terminal device 120 as the auxiliary beam. For example, in this case, the terminal device 120 may determine a CRI of 1 as the first index of the first-type beam 312 associated with the second-type beam 422, determine a PI of 2 as the second index of the second-type beam 422 in the plurality of second-type beams 421-424 and determine a signal quality of the reference signal in the second-type beam 422 (referred to as first signal quality for ease of discussion). The first index, the second index and the first signal quality are included in the beam information as the first indication.

The terminal device 120 may further determine a CRI of 1 as an index of the first-type beam 312 associated with the second-type beam 423 (referred to as third index for ease of discussion), determine a PI of 3 as a index of the second-type beam 423 in the plurality of second-type beams 421-424 (referred to as fourth index for ease of discussion) and determine a signal quality of the reference signal in the second-type beam 423 (referred to as second signal quality for ease of discussion). The third index, the fourth index and the second signal quality are included in the beam information as the second indication.

In the above example, the auxiliary beam (the second-type beam 423) and the selected beam (the second-type beam 422) are associated with the same first-type beam, i.e. the first-type beam 312. It is to be understood by a person skilled in the art that the auxiliary beam and the selected beam may be associated with different first-type beams. For example, the selected beam may be the first-type beam 421 and the auxiliary beam in this case may be a second-type beam associated with the first-type beam 311. Although only one auxiliary beam is described in the above example, it is to be understood that information on more than one auxiliary beam can be included in the beam information.

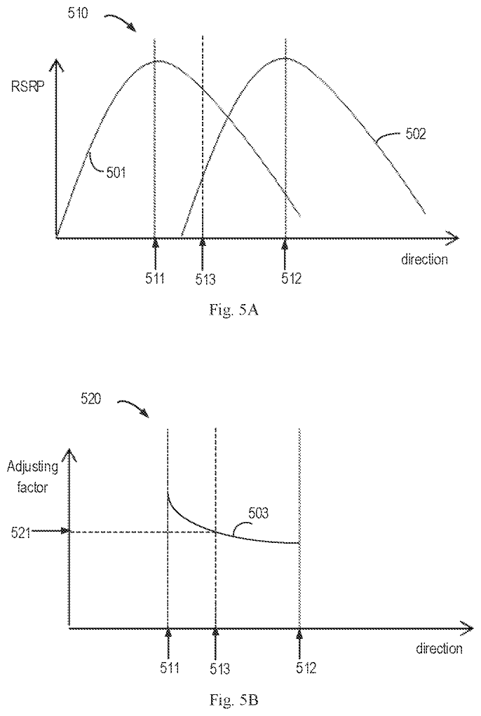

In these embodiments, since the signal qualities are also included in the beam information, the positioning of the terminal device 120 may be further adjusted based on the signal qualities. Now descriptions of the network device 110 how to adjust the positioning of the terminal device 120 will be made with reference to FIGS. 5A and 5B. FIG. 5A illustrates a graph of the RSRPs varying with beam direction according to some embodiments of the present disclosure. FIG. 5B illustrates a graph of an adjusting factor varying with beam direction according to some embodiments of the present disclosure.

As an example, the second-type beam 422 is the selected beam and the second-type beam 423 is the auxiliary beam. Graph 510 shows the RSRPs varying with the beam direction. The curves 501 and 502 show the RSRPs in the second-type beams 422 and 423, respectively. The arrows 511 and 512 indicate the beam center of the second-type beams 422 and 423, respectively. For ease of discussion, the RSRP in the second-type beam 422 is referred to as RSRP1 and the RSRP in the second-type beam 423 is referred to as RSRP2. The curve 503 in graph 520 show an adjusting factor which may determine based on the curves 501 and 502. The adjusting factor is used to modify the deviation of the direction of the terminal device 120 from a direction of the beam center. For example, the adjusting factor may be calculated as (RSRP1−RSRP2)/(RSRP1+RSRP2). It is to be understood that the above example of the adjusting factor is only for the purpose of illustration without suggesting any limitations.

In this case, the network device 110 may first determine, based on a direction of the second-type beam 422, a direction of the terminal device 120 relative to the network device 110 (also referred to as a first direction) and determine, based on a direction of the second-type beam 423, another direction of the terminal device 120 relative to the network device 110 (also referred to as a third direction). For example, the network device 110 may use the direction indicated by the arrow 511 as the first direction and use direction indicated by the arrow 512 as the third direction. The network device 110 may further determine the adjusting factor based on the RSRPs included in the beam information.

As an example, the network device 110 may determine that the adjusting factor is the value indicated by the arrow 521. Thus, the direction of the terminal device 120 may be determined as a direction between the arrow 511 and 512. The network device 110 may determine that the direction indicated by the arrow 513 is the direction of the terminal device 120, according to a predefined relation between the adjusting factor and the beam direction. In some cases, the network device 110 may determine the direction of the terminal device 120 based on a weight corresponding to the adjusting factor. After determining the direction of the terminal device 120 relative to the network device 110, the position of the terminal device 120 may be determined as described above with reference to FIG. 2.

The embodiments where the beam information is explicitly included in the uplink signal have been described above. As mentioned above, the beam information may be implicitly included in the uplink signal. In embodiments where the beam information is implicitly included in the uplink signal, at step 220 shown in FIG. 2, the terminal device 120 may transmit a random access preamble, e.g. over Physical Random Access Channel (PRACH). The random access preamble may indicate the beam information based on mapping between sequences of the random access preamble and the plurality of beams.

A predefined mapping relation between the random access preambles and the plurality of beams may be stored by both the network device 110 and the terminal device 120. For example, the indexes for the random access preamble may be used. For ease of discussion, an index for the random access preamble is referred to as a PRACH index. Each beam may be associated with a PRACH index mapped across any of sequence resources, frequency resources and time resources. For the second-type beam 422 with a CRI of 1 and a PI of 2, a corresponding PRACH index may be predefined as 12, and for the second-type beam 423 with a CRI of 1 and a PI of 3, a corresponding PRACH index may be predefined as 13. If the second-type beam 422 with a CRI of 1 and a PI of 2 is selected by the terminal device 120, then the terminal device 120 may transmit a random access preamble corresponding to the PRACH index of 12. It is to be understood that the above example of correspondence is only for the purpose of illustration without suggesting any limitations.

After receiving the random access preamble, the network device 110 may first determine the PRACH index, by interpreting the index of the received random access preamble. Then, the network device 110 may determine which beam has been selected by the terminal device 120 based on the predefined mapping relation between the PRACH indexes and the plurality of beams. In the above example, the network device 110 may first determine that the PRACH index corresponding to the sequences of the received random access preamble is 12 and determine that the selected beam is the second-type beam 422 with a CRI of 1 and a PI of 2 based on the predefined mapping relation. Thereafter, the network device 110 may determine the position of the terminal device 120 based on the second-type beam 422 with a CRI of 1 and a PI of 2 as described above with reference to FIG. 2.

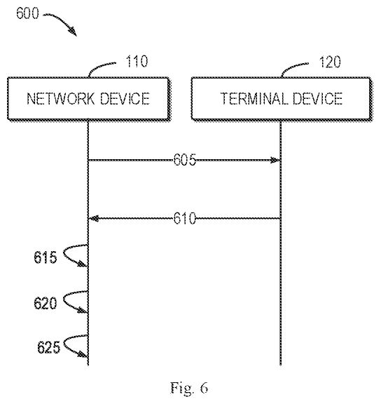

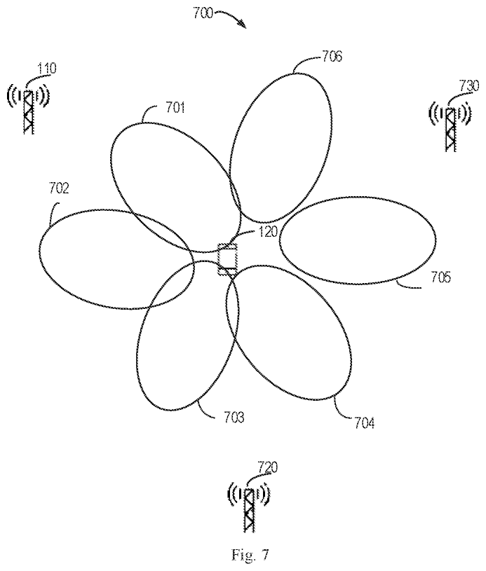

In the foregoing, embodiments where the network device 110 transmits downlink reference signals in a plurality of beams are described. In another aspect, there is provided another positioning method in which the terminal device 120 transmits a plurality of beams. FIG. 6 is a schematic diagram illustrating a process 600 for a beam based positioning. FIG. 7 is a schematic diagram 700 illustrating a plurality of beams 701-706 transmitted by the terminal device 120.

The network device 110 transmits 605 to the terminal device 120 a request for triggering an uplink positioning-related signal. In response to receiving from the network device 110 a request for triggering an uplink positioning-related signal, the terminal device 120 transmits 610 the uplink positioning-related signal in a plurality of beams 701-706 having different directions. For example, the uplink positioning-related signal may be PRACH or Sounding Reference Signal (SRS), or other dedicated positioning reference signal. As shown in FIG. 7, the terminal device 120 transmits the uplink positioning-related signal in the plurality of beams 701-706 to different network devices (the network devices 110, 720 and 730).

In response to receiving the uplink positioning-related signal from the terminal device in the plurality of beams 701-706, the network device 110 determines 615 signal qualities of the plurality of beams 701-706 based on the uplink positioning-related signal in the plurality of beams 701-706. As described above, the signal quality may be RSRP, CQI or SNR, etc. The network device 110 determines 620 a beam in the plurality of beams based on the determined signal qualities. In the illustrated case, the network device 110 may determine that the signal quality of the beam 702 is better than that in other beams 701 and 703-706 and the determined beam may be beam 702. Then, the network device 110 determines 625 a position of the terminal device 120 based at least in part on the uplink positioning-related signal in the determined beam 702.

The other network devices 720 and 730 may also receive the plurality of beams 701-706 transmitted by the terminal device 120 and select a beam from the plurality of beams 701-706 based on signal qualities of the plurality of beams 701-706. As an example, the network device 720 may use the uplink positioning-related signal in the beam 703 and the network device 730 may use the uplink positioning-related signal in the beam 705.

In some embodiments, the three network devices may cooperate with each other as in the conventional UTDOA based positioning method. For example, the network device 110 may determine, from the uplink positioning-related signal in the determined beam 702, a first time of arrive (TOA) of the uplink positioning-related signal. The network device 110 may obtain a second TOA of the uplink positioning-related signal for the network device 720. The second TOA may be determined by the network device 720 based on the uplink positioning-related signal in the beam 703. Then, the network device 110 may determine the position of the terminal device 120 based on the first TOA and the second TOA.

Alternatively or additionally, the network device 110 may further obtain a third TOA of the uplink positioning-related signal for the network device 730. The third TOA may be determined by the network device 730 based on the uplink positioning-related signal in the beam 705. Then, the network device 110 may determine the position of the terminal device 120 based on the first TOA, the second TOA and the third TOA as in the conventional UTDOA based method.

In these embodiments, by selecting a beam to be used based on signal qualities, the quality of the uplink positioning-related signal used by each of the network devices is ensured and accuracy of the determined TOA can be ensured. Therefore, the positioning accuracy is improved as compared to the conventional UTDOA based method.

FIG. 8 shows a flowchart of an example method 800 in accordance with some embodiments of the present disclosure. The method 800 can be implemented at a network device 110 as shown in FIG. 1. For the purpose of discussion, the method 800 will be described from the perspective of the network device 110 with reference to FIG. 1.

At block 810, the network device 110 transmits reference signals in a plurality of beams having different directions. At block 820, the network device 110 receives, from a terminal device, a signal indicating beam information of a beam selected from the plurality of beams by the terminal device based on signal qualities of the plurality of beams, the signal qualities being determined based on the reference signal transmitted in the plurality of beams. At block 830, the network device 110 determines a position of the terminal device based at least in part on the beam information.

In some embodiments, the beam information comprises a first index of the selected beam.

In some embodiments, the beam information comprises a first index of an first-type beam associated with the selected beam and a second index of the selected beam in a plurality of second-type beams associated with the first-type beam.

In some embodiments, determining the position of the terminal device comprises: determining, based on a direction of the selected beam, a first direction of the terminal device relative to the network device; obtaining a second direction of the terminal device relative to a further network device; and determining the position of the terminal device based on the first direction and the second direction.

In some embodiments, determining the position of the terminal device comprises: determining, based on a direction of the selected beam, a first direction of the terminal device relative to the network device; obtaining a distance of the terminal device relative to the network device; and determining the position of the terminal device based on the first direction and the distance.

In some embodiments, the beam information comprises a first indication and a second indication. The first indication comprises a first index of the selected beam and a first signal quality of the reference signal in the selected beam, and the second indication comprises a third index of a further beam in the plurality of beams and a second signal quality of the reference signal in the further beam, the further beam being different from the selected beam.

In some embodiments, the beam information comprises a first indication and a second indication. The first indication comprises a first index of a first first-type beam associated with the selected beam, a second index of the selected beam in a plurality of second-type beams associated with the first first-type beam and a first signal quality of the reference signal in the selected beam. The second indication comprises a third index of a second first-type beam associated with a further beam in the plurality of beams, a fourth index of the further beam in a plurality of second-type beams associated with the second first-type beam and a second signal quality of the reference signal in the further beam, the further beam being different from the selected beam.

In some embodiments, determining the position of the terminal device comprises: determining, based on a direction of the selected beam, a first direction of the terminal device relative to the network device; determining, based on a direction of the further beam, a third direction of the terminal device relative to the network device; determining an adjusting factor based on the first signal quality and the second signal quality; and determining the position of the terminal device based at least in part on the first direction, the third direction and the adjusting factor.

In some embodiments, receiving the signal comprises receiving a random access preamble, the random access preamble indicating the beam information based on mapping between the random access preambles and the plurality of beams.

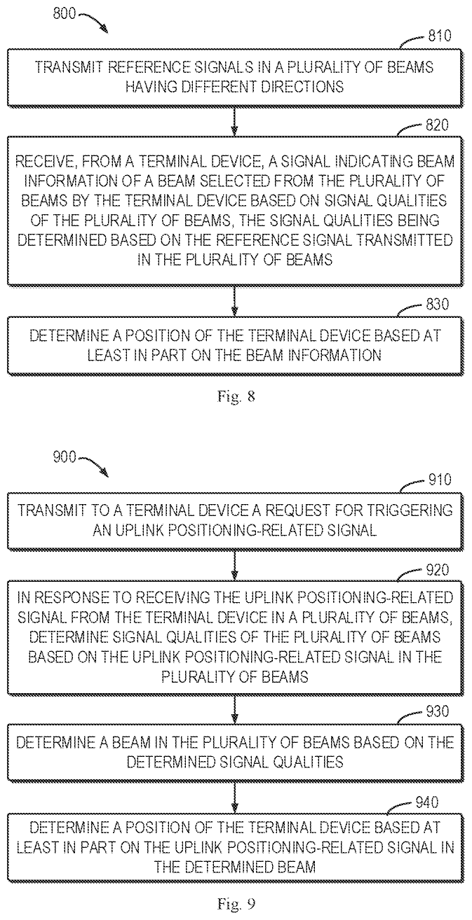

FIG. 9 shows a flowchart of an example method 900 in accordance with some other embodiments of the present disclosure. The method 900 can be implemented at a network device 110 as shown in FIG. 1. For the purpose of discussion, the method 900 will be described from the perspective of the network device 110 with reference to FIG. 1.

At block 910, the network device 110 transmits to a terminal device a request for triggering an uplink positioning-related signal. At block 920, in response to receiving the uplink positioning-related signal from the terminal device in a plurality of beams, the network device 110 determines signal qualities of the plurality of beams based on the uplink positioning-related signal in the plurality of beams. At block 930, the network device 110 determines a beam in the plurality of beams based on the determined signal qualities. At block 940, the network device 110 determines a position of the terminal device based at least in part on the uplink positioning-related signal in the determined beam.

In some embodiments, determining the position of the terminal device comprising: determining, from the uplink positioning-related signal in the determined beam, a first time of arrive (TOA) of the uplink positioning-related signal; obtaining a second TOA of the uplink positioning-related signal for a further network device; and determining the position of the terminal device based on the first TOA and the second TOA

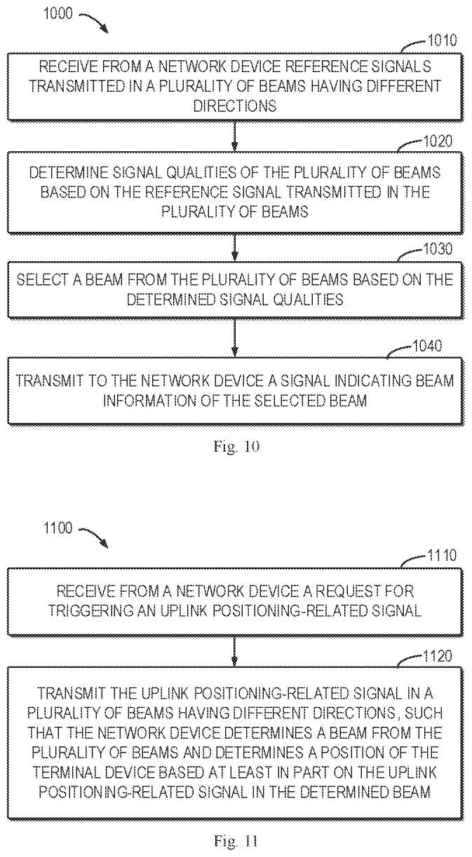

FIG. 10 shows a flowchart of an example method 1000 in accordance with some further embodiments of the present disclosure. The method 1000 can be implemented at a terminal device 120 as shown in FIG. 1. For the purpose of discussion, the method 1000 will be described from the perspective of the terminal device 120 with reference to FIG. 1.

At block 1010, the terminal device 120 receives from a network device reference signals transmitted in a plurality of beams having different directions. At block 1020, the terminal device 120 determines signal qualities of the plurality of beams based on the reference signal transmitted in the plurality of beams. At block 1030, the terminal device 120 selects a beam from the plurality of beams based on the determined signal qualities. At block 1040, the terminal device 120 transmits to the network device a signal indicating beam information of the selected beam.

In some embodiments, the method further comprises determining a first index of the selected beam. And transmitting the signal indicating the beam information comprises: transmitting the signal indicating the beam information comprising the first index.

In some embodiments, the method further comprises: determining a first index of a first-type beam associated with the selected beam and a second index of the selected beam in a plurality of second-type beams associated with the first-type beam. And transmitting the signal indicating the beam information comprises: transmitting the signal indicating the beam information comprising the first index and the second index.

In some embodiments, the method further comprises: determining a first index of the selected beam and a first signal quality of the reference signal in the selected beam; determining a third index of a further beam in the plurality of beams and a second signal quality of the reference signal in the further beam, the further beam being different from the selected beam. And transmitting the signal indicating the beam information comprises: transmitting the signal indicating the beam information comprising a first indication and a second indication, the first indication comprising the first index and the first signal quality, the second indication comprising the third index and the second signal quality.

In some embodiments, the method further comprises: determining a first index of a first first-type beam associated with the selected beam, a second index of the selected beam in a plurality of second-type beams associated with the first first-type beam and a first signal quality of the reference signal in the selected beam; determining a third index of a second first-type beam associated with a further beam in the plurality of beams, a fourth index of the further beam in a plurality of second-type beams associated with the second first-type beam and a second signal quality of the reference signal in the further beam, the further beam being different from the selected beam. And transmitting the signal indicating the beam information comprises: transmitting the signal indicating the beam information comprising a first indication and a second indication, the first indication comprising the first index, the second index and the first signal quality, the second indication comprising the third index, the fourth index and the second signal quality.

In some embodiments, transmitting the signal comprises transmitting a random access preamble. The random access preamble indicates the beam information based on mapping between the random access preambles and the plurality of beams.

FIG. 11 shows a flowchart of an example method 1100 in accordance with some yet further embodiments of the present disclosure. The method 1100 can be implemented at a terminal device 120 as shown in FIG. 1. For the purpose of discussion, the method 1000 will be described from the perspective of the terminal device 120 with reference to FIG. 1.

At block 1110, the terminal device 120 receives from a network device a request for triggering an uplink positioning-related signal. At block 1120, the terminal device 120 transmits the uplink positioning-related signal in a plurality of beams having different directions, such that the network device determines a beam from the plurality of beams and determines a position of the terminal device based at least in part on the uplink positioning-related signal in the determined beam.

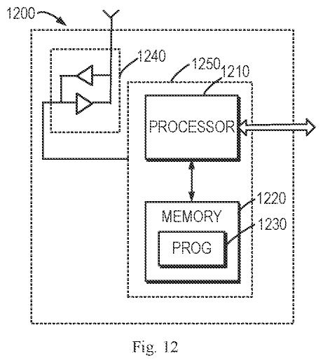

FIG. 12 is a simplified block diagram of a device 1200 that is suitable for implementing embodiments of the present disclosure. The device 1200 can be considered as a further example implementation of a network device 110 or a terminal device 120 as shown in FIG. 1. Accordingly, the device 1200 can be implemented at or as at least a part of the network device 110 or the terminal device 120.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the device 1200 to operate in accordance with the embodiments of the present disclosure, as discussed herein with reference to FIGS. 2 to 4 and FIGS. 9 to 12. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1210 may form processing means 1250 adapted to implement various embodiments of the present disclosure.

The memory 1210 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1210 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIG. 2, FIG. 6 and FIGS. 8-11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method implemented in a network device, comprising:
transmitting reference signals in a plurality of beams having different directions;
receiving, from a terminal device, a signal indicating beam information of a beam selected from the plurality of beams by the terminal device based on signal qualities of the plurality of beams, the signal qualities being determined based on the reference signal transmitted in the plurality of beams; and
determining a position of the terminal device based at least in part on the beam information.

2. The method of claim 1, wherein the beam information comprises a first index of the selected beam.

3. The method of claim 1, wherein the beam information comprises a first index of an first-type beam associated with the selected beam and a second index of the selected beam in a plurality of second-type beams associated with the first-type beam.

4. The method of claim 1, wherein determining the position of the terminal device comprises:
determining, based on a direction of the selected beam, a first direction of the terminal device relative to the network device;
obtaining a second direction of the terminal device relative to a further network device; and
determining the position of the terminal device based on the first direction and the second direction.

5. The method of claim 1, wherein determining the position of the terminal device comprises:
determining, based on a direction of the selected beam, a first direction of the terminal device relative to the network device;
obtaining a distance of the terminal device relative to the network device; and
determining the position of the terminal device based on the first direction and the distance.

6. The method of claim 1, wherein the beam information comprises a first indication and a second indication,
the first indication comprises a first index of the selected beam and a first signal quality of the reference signal in the selected beam, and
the second indication comprises a third index of a further beam in the plurality of beams and a second signal quality of the reference signal in the further beam, the further beam being different from the selected beam.

7. The method of claim 1, wherein the beam information comprises a first indication and a second indication,
the first indication comprises a first index of a first first-type beam associated with the selected beam, a second index of the selected beam in a plurality of second-type beams associated with the first first-type beam and a first signal quality of the reference signal in the selected beam, and
the second indication comprises a third index of a second first-type beam associated with a further beam in the plurality of beams, a fourth index of the further beam in a plurality of second-type beams associated with the second first-type beam and a second signal quality of the reference signal in the further beam, the further beam being different from the selected beam.

8. The method of claim 6, wherein determining the position of the terminal device comprises:
determining, based on a direction of the selected beam, a first direction of the terminal device relative to the network device;
determining, based on a direction of the further beam, a third direction of the terminal device relative to the network device;
determining an adjusting factor based on the first signal quality and the second signal quality; and
determining the position of the terminal device based at least in part on the first direction, the third direction and the adjusting factor.

9. The method of claim 1, wherein receiving the signal comprises receiving a random access preamble, the random access preamble indicating the beam information based on mapping between the random access preambles and the plurality of beams.

10. A method implemented in a network device, comprising:
transmitting to a terminal device a request for triggering an uplink positioning-related signal;
in response to receiving the uplink positioning-related signal from the terminal device in a plurality of beams, determining signal qualities of the plurality of beams based on the uplink positioning-related signal in the plurality of beams;
determining a beam in the plurality of beams based on the determined signal qualities; and
determining a position of the terminal device based at least in part on the uplink positioning-related signal in the determined beam.

11. The method of claim 10, wherein determining the position of the terminal device comprising:
determining, from the uplink positioning-related signal in the determined beam, a first time of arrive (TOA) of the uplink positioning-related signal;
obtaining a second TOA of the uplink positioning-related signal for a further network device; and
determining the position of the terminal device based on the first TOA and the second TOA.

12. A method implemented in a terminal device, comprising:
receiving from a network device reference signals transmitted in a plurality of beams having different directions;
determining signal qualities of the plurality of beams based on the reference signal transmitted in the plurality of beams;
selecting a beam from the plurality of beams based on the determined signal qualities; and
transmitting to the network device a signal indicating beam information of the selected beam.

13. The method of claim 12, further comprising:
determining a first index of the selected beam; and
wherein transmitting the signal indicating the beam information comprises: transmitting the signal indicating the beam information comprising the first index.

14. The method of claim 12, further comprising:
determining a first index of a first-type beam associated with the selected beam and a second index of the selected beam in a plurality of second-type beams associated with the first-type beam; and
wherein transmitting the signal indicating the beam information comprises: transmitting the signal indicating the beam information comprising the first index and the second index.

15. The method of claim 12, further comprising:
determining a first index of the selected beam and a first signal quality of the reference signal in the selected beam;
determining a third index of a further beam in the plurality of beams and a second signal quality of the reference signal in the further beam, the further beam being different from the selected beam; and
wherein transmitting the signal indicating the beam information comprises: transmitting the signal indicating the beam information comprising a first indication and a second indication, the first indication comprising the first index and the first signal quality, the second indication comprising the third index and the second signal quality.

16. The method of claim 12, further comprising:
determining a first index of a first first-type beam associated with the selected beam, a second index of the selected beam in a plurality of second-type beams associated with the first first-type beam and a first signal quality of the reference signal in the selected beam;
determining a third index of a second first-type beam associated with a further beam in the plurality of beams, a fourth index of the further beam in a plurality of second-type beams associated with the second first-type beam and a second signal quality of the reference signal in the further beam, the further beam being different from the selected beam; and
wherein transmitting the signal indicating the beam information comprises: transmitting the signal indicating the beam information comprising a first indication and a second indication, the first indication comprising the first index, the second index and the first signal quality, the second indication comprising the third index, the fourth index and the second signal quality.

17. The method of claim 12, wherein transmitting the signal comprises transmitting a random access preamble, the random access preamble indicating the beam information based on mapping between the random access preambles and the plurality of beams.

18-26. (canceled)
